(19) United States
(12) Patent Application Publication
(10) Pub. No.: US 2010/0205146 A1
(43) Pub. Date: Aug. 12, 2010

(54) Methods for Utilizing the Resources of a Digital Display Device by a Computer

(75) Inventors: Yong Wan, Shanghai (CN); Jinsong Han, Shanghai (CN); Qiang Wang, Shanghai (CN); Zhao Rong Pan, Shanghai (CN); Michael Yip, Los Altos, CA (US)

Correspondence Address: Venture Pacific Law, PC, 5201 Great America Parkway, Suite 270, Santa Clara, CA, 95054, US

(73) Assignee: AMLOGIC CO., LTD., Santa Clara, CA (US)

(21) Appl. No.: 12/684,107

(22) Filed: Jan. 7, 2010

Related U.S. Application Data
(60) Provisional application No. 61/143,157, filed on Jan. 7, 2009.

(51) Int. Cl. G06F 17/30; G06F 3/048; G06F 12/16; G06F 12/14

(52) U.S. Cl. 707/617; 715/781; 707/640; 707/781; 707/E17.005; 707/E17.009; 707/E17.044

(57) ABSTRACT

A method for utilizing the resources of a digital display device (“DDD”) for use by a computer comprises the steps of: connecting the DDD to the computer; displaying one or more images on the DDD, wherein the images are transmitted from the computer to the DDD; updating and storing PIM information on the DDD, wherein the PIM information is retrieved from the computer; and generating by the DDD one or more alerts based on the updated PIM information to be displayed on the DDD.

### CROSS REFERENCE

This application claims priority from a provisional patent application entitled “Methods for Utilizing the Resources of a Digital Display Device by a Computer” filed on Jan. 7, 2009 and having an Application No. 61/143,157. Said application is incorporated herein by reference.

### FIELD OF INVENTION

This invention relates to methods for utilizing the resources of a digital display device (“DDD”), and, in particular, to methods for utilizing the resources of the DDD by a computer connected to the DDD.

### BACKGROUND

A digital display device (“DDD”), such as a digital picture frame (“DPF”), provides for the display of a collection of photos, images, videos, and other content. FIG. 1 illustrates the results of displaying an image on a DDD. Generally, a DDD displays content stored in its internal memory or from a locally connected storage device (e.g. flash memory). The DDD may also connect directly to a computer via a USB connection (or through a network connection) to download content from the computer to the DDD. The DDD can then display the content in a predefined format or a user specified format. However, this interaction fails to fully utilize the resources of the DDD for use by the connected computer.

Therefore, it is desirable to provide methods for a computer to use the resources of a DDD connected to that computer.

### SUMMARY OF INVENTION

An object of this invention is to provide methods for utilizing the resources of a DDD by a computer connected to the DDD.

Another object of this invention is to provide methods for using a DDD as an additional monitor for a computer.

Yet another object of this invention is to provide methods for generating alerts on a DDD according to a personal information manager software of a computer.

Briefly, the present invention discloses a method for utilizing the resources of a digital display device for use by a computer, comprising the steps of: connecting the DDD to the computer; displaying images on the DDD, wherein the images are transmitted from the computer to the DDD; updating PIM information on the DDD, wherein the PIM information is retrieved from the computer; and generating alerts based on the updated PIM information to be displayed on the DDD.

An advantage of this invention is that methods are provided for utilizing the resources of a DDD by a computer connected to the DDD.

Another advantage of this invention is that methods are provided for using a DDD as an additional monitor for a computer.

Yet another advantage of this invention is that methods are provided for generating alerts on a DDD according to a personal information manager software of a computer.

### DESCRIPTION OF THE DRAWINGS

The foregoing and other objects, aspects, and advantages of the invention will be better understood from the following detailed description of the preferred embodiment of the invention when taken in conjunction with the accompanying drawings in which:

FIG. 1 illustrates the results of a prior art method for displaying an image on a DDD.

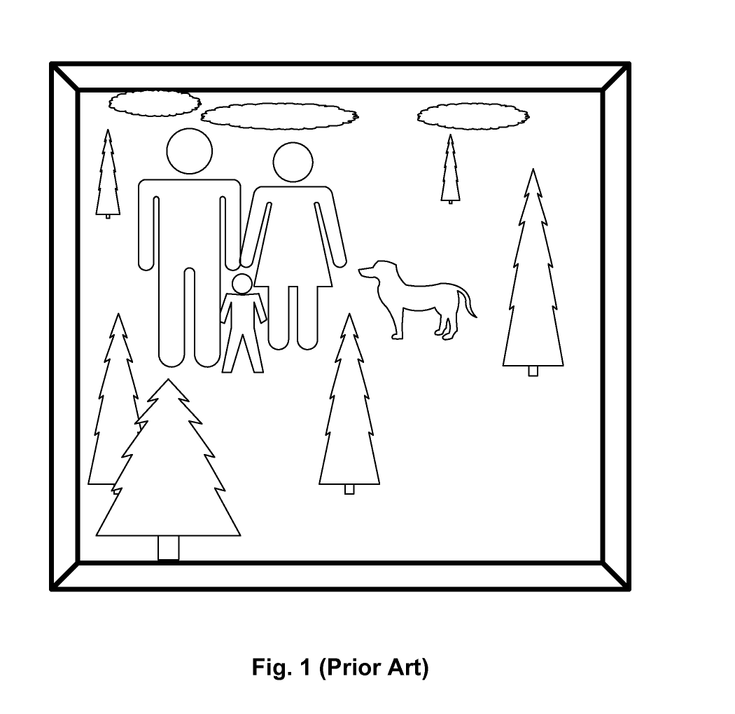

FIG. 2 illustrates the results of using a DDD as a dual screen for a computer.

FIG. 3 illustrates a process flow for utilizing the resources of a DDD by a computer connected to the DDD.

FIG. 4 illustrates the results of displaying an alert message on a DDD.

FIG. 5 illustrates the results of displaying an alert message on a DDD.

### DETAILED DESCRIPTION OF THE PREFERRED EMBODIMENTS

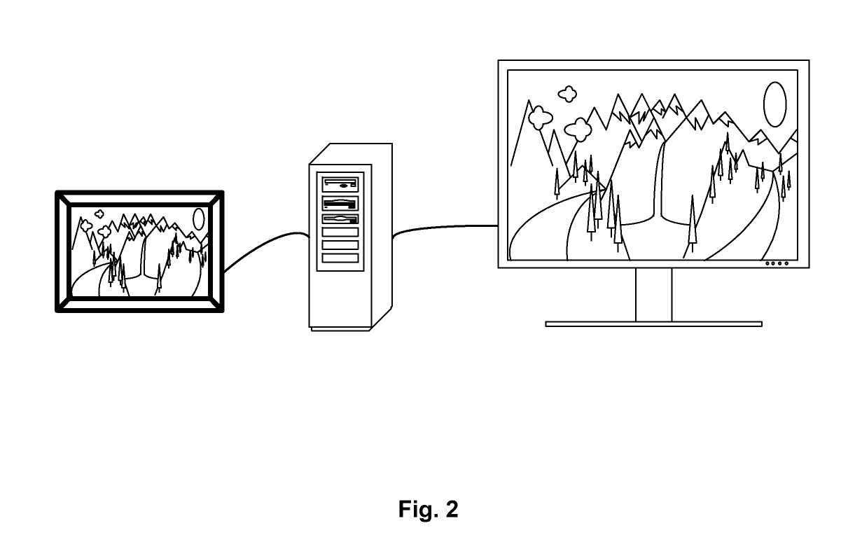

FIG. 2 illustrates the results of using a DDD as a dual screen for a computer, wherein the DDD displays a substantially similar image as the computer's screen. The DDD can support various video connections (e.g. VGA, Super VGA, DVI, and video component), audio connections (e.g. analog and digital), audio/video connections (e.g. coaxial cable and HDMI), universal serial bus (“USB”) connections, network connections, and other means for connecting the DDD to other devices.

Utilizing these connections, a computer can transmit images to display on the DDD's screen. For instance, a desktop computer can be connected to a DDD via a VGA connection. Once connected, the desktop computer can use the DDD as a dual display for the desktop computer, wherein the desktop computer can extend the desktop computer's display to cover the area displayed by the DDD; thus increasing the work area for a user of the desktop computer. Alternatively, the DDD can display a clone of the desktop computer's screen (illustrated in FIG. 2).

Furthermore, a computer can be connected to a DDD via a USB connection, wherein the computer can display images on the DDD via the USB connection. The USB connection can also be used to connect the local storage of the DDD for use by the computer. In this respect, the computer can use the local storage of the DDD for its usage. For instance, the computer can use the local storage of the DDD as a temporary memory, primary storage, secondary storage, or for other storage schemes. When the DDD is disconnected, then the information stored on the DDD can be purged from the DDD's memory or can be retained based on the computer's settings and the DDD's settings.

Additionally, when the computer is connected to the DDD, the DDD can download personal information for use in personal information manager (“PIM”) software stored in a computer's storage device. Personal information, herein referred to as PIM information, can include personal notes/journals, address book, a tasks list, significant calendar dates (e.g. birthdays, anniversaries, and appointments and meetings), reminders, email archives, and other information. The DDD can serve as an extension of the PIM software by displaying alerts and archiving information for use by the PIM software on the DDD. This is true even when the DDD is disconnected from the computer since that information is stored on the local storage drive of the DDD. The computer can also download PIM information from the DDD.

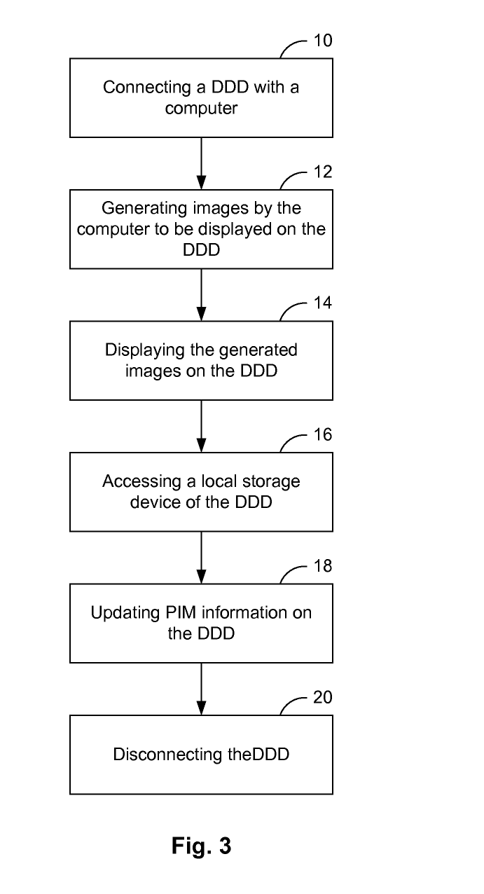

FIG. 3 illustrates a process flow for utilizing the resources of a DDD by a computer connected to the DDD. First a computer is connected with a DDD 10, preferably by a USB connection. The computer can display images via this connection on the DDD by generating images to be displayed on the DDD 12, and then having the DDD display the generated images 14. Also, through this connection the computer can access the local storage device of the DDD 16. Furthermore, via this connection, the PIM information can be downloaded to the DDD to update the PIM information on the DDD 18. Finally, the DDD can be disconnected from the computer 20.

In an embodiment of the present invention, the computer can also access the processing unit of the DDD and utilize that processing unit for the computer's use. Thus, the processing power of the DDD and the computer are aggregated. The connection can be disconnected when the resources of the DDD are no longer needed.

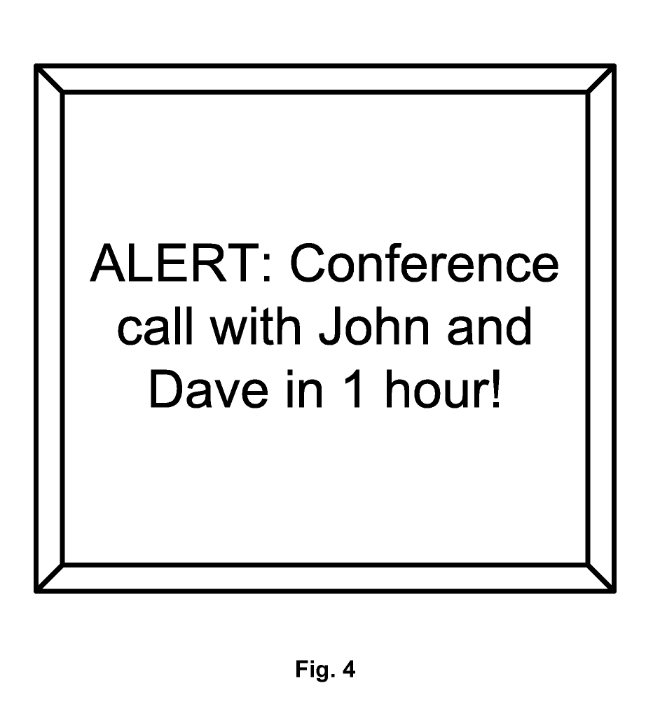

FIG. 4 illustrates the results of displaying an alert message on a DDD. Once PIM information is stored on the DDD, alert messages can be displayed to alert the user of specified dates from the PIM information. For instance, if the user has a conference call within an hour, then the PIM software can display the alert an hour from when the conference call is scheduled. The alerts can be scheduled by the PIM software, preset by the user, or automatically generated by the DDD.

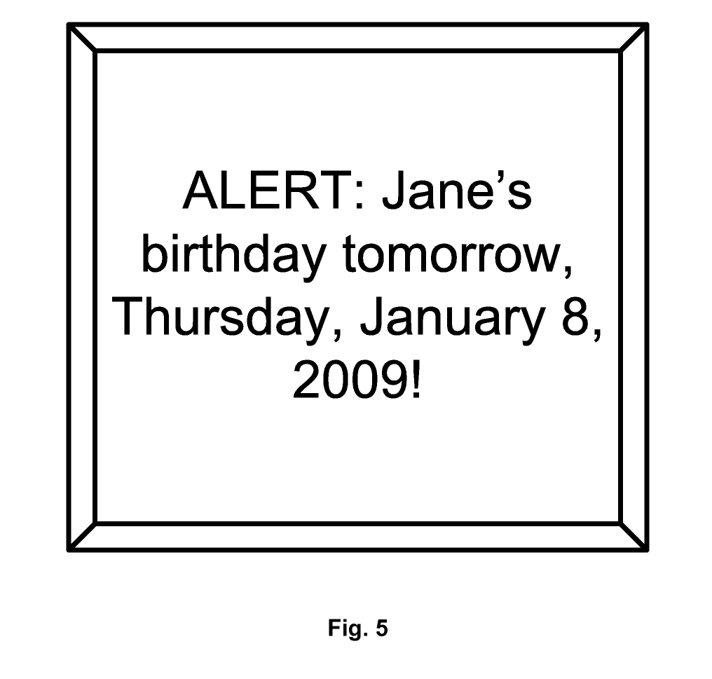

FIG. 5 illustrates the results of displaying an alert message on a DDD. Here, the DDD automatically displays birth date alerts a predefined number of days before a birthday. As stated above, it would be appreciated that the alerts can be scheduled by the PIM software, preset by the user, or automatically generated by the DDD.

### Alternative Embodiments

When a DPF of the present invention is connected to a host computer, the DPF (or DDD) of the present invention becomes an additional resource to the host computer. In one respect, the software component of the present invention automatically detects that the DPF of the present invention is connected to the host computer. The software component of the present invention residing on the host computer (and/or the DPF) is activated by the connection and the protocol between the host computer and the DPF is initiated. Once the initiation is completed, in one implementation, the DPF becomes an extended desktop for the host computer, such that application windows may be displayed on the DPF.

In an embodiment of the present invention, a video player application can automatically play a movie, a selected content stream (e.g. radio, TV or video stream) or a set of image files when a DPF is connected to a host computer. The video player software can reside in the DPF such that the video player does not need to be installed on the host computer. The video player can play content located in the storage device of the DPF or a pre-defined storage location on the host computer. Thus the user can enjoy the use of the DPF for entertainment while working on the host computer.

In another embodiment of the present invention, the host computer can direct the DPF to display applications running on the host computer. Here, the DPF can be an extended desktop display for the host computer. For instance, the user can direct an application window to be displayed on the DPF and normally operate the application window on the DPF, while the programming is running on the host computer.

In yet another embodiment of the present invention, the host computer directs the DPF to perform specific functions. Here, the processing power of the DPF is utilized to perform certain tasks. The DPF can be loaded with a simple operating system such as a simple version of linux/unit/freebsd where certain applications are built-in to the DPF, while other applications may be added as desired. The host computer can connect with the DPF through a remote management software, such as VNC, to manage data on the DPF and to add/remove programs from the DPF. For instance, the DPF can be scheduled to activate a selected application at a specified time. The DPF can also be directed to download data and software updates during off-hours (i.e., when the network connection used by the DPF is not busy). The remote connection can be implemented by a wired or wireless network connection, Bluetooth, or other remote connection type.

In yet another embodiment of the present invention, the DPF can be programmed to act as a backup/synchronization device. When a host computer device is connected to a DPF of the present invention, the content in a pre-defined folder on the host computer can be automatically synchronized with the content of a pre-defined folder of the DPF.

In the synchronization process, an image file being transferred from the host computer to the DPF can be displayed from a window on the host computer to the display of the DPF such that the image appears to move or flow from the host computer to the DPF. The same display process can be applied when image files are transferred from the DPF to the host computer. This synchronization and viewing/displaying process can be an automated process or a manual process performed when image files are transferred between the DPF and the host computer. This embodiment allows the use of the DPF as a backup device.

Since the DPF generally does not attract attention as a storage device, it can be a good place for storing important information. A portion of the DPF can be encrypted (e.g. using Truecrypt) requiring a password for access. Sensitive information that a user wishes to keep secret in a safe location can therefore be carried out and no one would suspect such location for keeping important information.

The various embodiments described above can also be implemented as various modes of the DPF.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for utilizing the resources of a digital display device (“DDD”) for use by a computer, comprising the steps of:
connecting the DDD to the computer;
displaying one or more images on the DDD, wherein the images are transmitted from the computer to the DDD and stored in the DDD;
updating and storing PIM information from the computer to the DDD; and
generating by the DDD one or more alerts based on the stored PIM information to be displayed on the DDD.

2. The method of claim 1 wherein the images correspond to an application running on the computer.

3. The method of claim 1 further comprising the step, after the connecting step, of aggregating the processing power of the DDD and the computer.

4. The method of claim 1 further comprising the step, after the connecting step, of aggregating the storage of the DDD and the computer.

5. The method of claim 1 wherein in the updating step, the computer downloads PIM information from the DDD.

6. The method of claim 1 wherein the computer is remotely connected to the DDD.

7. The method of claim 1 wherein the DDD automatically backs up data of the computer.

8. The method of claim 1 wherein the DDD stores password protected data for use by the computer.

9. A method for utilizing the resources of a digital display device for use by a computer, comprising the steps of:
connecting the DDD to the computer;
displaying one or more images on the DDD, wherein the images are transmitted from the computer to the DDD and stored in the DDD and wherein the images correspond to an application running on the computer;
aggregating the processing power of the DDD and the computer;
updating and storing PIM information on the DDD, wherein the PIM information is retrieved from the computer; and
generating by the DDD one or more alerts based on the stored PIM information to be displayed on the DDD.

10. The method of claim 9 further comprising the step after the connecting step of, aggregating the storage of the DDD and the computer.

11. The method of claim 9 wherein in the updating step, the computer downloads PIM information from the DDD.

12. The method of claim 9 wherein the computer is remotely connected to the DDD.

13. The method of claim 9 wherein the DDD automatically backs up data of the computer.

14. The method of claim 9 wherein the DDD stores password protected data for use by the computer.

15. A method for utilizing the resources of a digital display device for use by a computer, comprising the steps of:
connecting the DDD to the computer, wherein the computer is remotely connected to the DDD;
displaying one or more images on the DDD, wherein the images are transmitted from the computer to the DDD and wherein the images correspond to an application running on the computer;
aggregating the processing power of the DDD and the computer;
aggregating the storage of the DDD and the computer;
updating and storing PIM information on the DDD, wherein the PIM information is retrieved from the computer; and
generating by the DDD one or more alerts based on the stored PIM information to be displayed on the DDD.

16. The method of claim 15 wherein in the updating step, the computer downloads PIM information from the DDD.

17. The method of claim 15 wherein the DDD automatically backs up data of the computer.

18. The method of claim 15 wherein the DDD stores password protected data for use by the computer.
